(19) United States
(12) Patent Application Publication
(10) Pub. No.: US 2005/0214087 A1
(43) Pub. Date: Sep. 29, 2005

(54) Spacer adapter for toolholders

(76) Inventors: John Stilianos Agapiou, Rochester Hills, MI (US); Robert K. Aas, Ypsilanti, MI (US)

Correspondence Address: General Motors Corporation;Legal Staff, Mail Code 482-C23-B21, P.O. Box 300, Detroit, MI, 48265-3000, US

(21) Appl. No.: 10/811,159

(22) Filed: Mar. 26, 2004

(51) Int. Cl. B23C 1/00

(52) U.S. Cl. 409/141

(57) ABSTRACT

A toolholder for a cutting tool is disclosed for use with a machine tool having a main shaft or spindle with a flared or tapered end socket. The toolholder has a tool-holding end for a cutting tool and a tapered shank end for placement in the tapered socket of the machine tool spindle. The toolholder also has an annular flange near its tapered shank, the flange or collar generally being used for location and gripping by a tool exchange mechanism. An elastic spacer ring is used and compressed between said flange and the face of said machine tool shaft in machining operations for dampening vibrations and flexing of the toolholder and cutting tool.

### TECHNICAL FIELD

This invention pertains to use of an elastic spacer between a toolholder and the face of a machine tool spindle. More specifically, this invention relates to the use of such a compressible spacer between the flange of a toolholder and a spindle to provide improved vibration damping and dynamic bending stiffness for milling and boring operations.

### BACKGROUND OF THE INVENTION

Machine tools operated under computer numerical control (CNC) are widely used in manufacturing operations. For example, in automobile manufacturing they are used in milling and boring operations in making engine blocks and transmission cases. Machine tools are often used in machining centers and the tools may be designed for horizontal, vertical or multi-axis operation. A sophisticated machine tool provides the motive power and direction for the cutting operation and a suitable cutting tool provides means for shaping the metallic workpiece. A toolholder provides the interface between the main rotating shaft (spindle) of the machine tool and the cutting tool. The design of the toolholder has a strong influence on machining cost and the accuracy and stability of the metal cutting operation.

A common toolholder in use for CNC machine tools has a tapered shank for insertion in a machine tool. The spindle of the machine tool has a tapered (truncated conical) socket at its end for receiving the complementary tapered shank of a toolholder. A boring or milling tool is secured with a collet or clamp in the opposite axial end of the toolholder. The toolholder also has a gripping flange or collar with a V-groove located between the tapered end and the tool receiving end. The grooved flange is engaged by a tool changer mechanism to insert and remove the toolholder into and from the end of the spindle.

The principal contact between the toolholder and machine tool spindle is at the tapered surfaces of the toolholder shank and machine tool socket. Both surfaces are carefully machined within practical tolerances, but perfect fits cannot be attained as a practical matter. The machine tool spindle rotates at speeds varying from a few hundred rpm to several thousand rpm depending on the size of the cutting tool and load requirements of the cutting operation. The centers of rotation of the toolholder (and tool) and the spindle are often slightly out of alignment with resultant vibration and wobble in the rotation of the cutting tool. There is a continual need to improve the dimensional accuracy of machining operations and to increase the speed at which they are accomplished. It is an object of this invention to improve the interface between a toolholder and the spindle of a machine tool by providing higher vibration damping characteristics for faster and more precise milling of surfaces and boring of holes in metal workpieces.

### SUMMARY OF THE INVENTION

A ring of elastically deformable material is fitted on the circumference of the toolholder between the tool exchanger flange and the large diameter portion of its tapered shank. This ring serves as a compressible or deformable vibration dampening spacer between the flange on the circumference of the toolholder and the face of the spindle shaft of the machine tool. The thickness of the elastic spacer material fills the space between one side of the flange and the face of the spindle when the clamping mechanism of the machine tool pulls the tapered shank of the toolholder into the tapered socket of the spindle. When the toolholder is secured in the spindle by operation of the machine tool the elastic spacer is thus compressed, like a washer, to significantly dampen rotational vibrations arising during machining from imperfect fits between the tapered surfaces of the toolholder shank and the spindle socket.

The elastic spacer is made of a suitable material such as rubber or other relatively flexible polymer material. Matted or felted fibrous materials may also have suitable flexibility for spacer application. In the operation of the machine tool the spindle rotates and pushes the milling or boring tool against a machinable workpiece. The machining forces on the tool cause vibrations in the rotating combination of machine tool spindle, toolholder and tool. The fit of the toolholder shank into the spindle socket cannot be perfect and the rotation of the tool is eccentric with respect to the rotation of the spindle, and the tool bends, flexes and vibrates and chatters. This motion of the tool affects the dimensional accuracy of the machining operation. But the elastic spacer, compressed between the toolholder flange and the spindle face, markedly reduces the vibration and chatter of the tool. Chatter is a dynamic phenomenon that can appear in machining at any spindle speed as a result of self-excited vibration. The use of the low cost elastic spacer-damper provides great benefit to the accuracy of the machining operation.

The selection of a suitable or preferred vibration dampening spacer material for a specific toolholder-spindle combination depends on the nature (e.g., aggressiveness of material removal) of the intended machining operation and the physical properties of the machining system. As will be described, there are experimental/analytic practices, based on known mathematical frequency response functions, for determining the vibration modal characteristics of a damped or un-damped toolholder/spindle system interface. And, given the ease with which one elastic material ring can be exchanged for another, trial placements of vibration dampening spacers will soon identify favorable candidates.

Other objects and advantages of the invention will become more apparent from descriptions of preferred embodiments which follow.

### BRIEF DESCRIPTION OF THE DRAWINGS

FIG. 1 is an exploded side view of the toolholder receiving face of a machine tool spindle, a toolholder with a V-groove flange and a tapered shank for insertion in the spindle socket, and an elastic vibration damper spacer for placement between the face of the machine tool spindle and the toolholder flange.

FIG. 2 is an enlarged view of a portion of FIG. 1, partly in cross-section, showing the fit between the toolholder flange, the vibration damper spacer and the face of the machine tool spindle.

FIGS. 3A and 3B are frequency response function (FRF) graphs of real (FIG. 3A) and imaginary values (FIG. 3B) of the ratio of system displacement to an exciting force (m/N) as a function of vibration frequency (Hz). The solid data line is for a CAT-40 Toolholder-Spindle interface with a vinyl rubber vibration damper spacer at the interface (FC) and the dashed line is for the CAT-40 Toolholder-Spindle interface with no damper at the interface (NFC).

FIGS. 4A and 4B are FRF graphs of real (FIG. 4A) and imaginary values (FIG. 4B) of the ratio of system displacement to an exciting force (m/N) as a function of vibration frequency (Hz). The solid data line is for a CAT-40 Toolholder-Spindle interface with a vinyl rubber vibration damper spacer at the interface and the dashed line is for the CAT-40 Toolholder-Spindle interface with a polyurethane vibration damper spacer at the interface.

### DESCRIPTION OF PREFERRED EMBODIMENTS

CNC machine tools are used worldwide in workpiece metal removal operations such as milling surfaces and boring holes. In the automobile industry machine tools are used, for example, in machining die cast aluminum alloy automatic transmission cases and cast aluminum or ferrous alloy cylinder blocks and cylinder heads for engines. In machining centers a given machine tool may perform a series of different machining operations on the same or different workpieces assisted by a programmed, mechanized tool changer that substitutes different cutting tools in the spindle, or main rotating shaft, of the CNC machine. There is always a desire to increase the rate of metal removal from the workpiece and the dimensional accuracy of the machined surfaces.

A toolholder is used to attach a milling or boring tool to the spindle of the CNC machine tool and the CNC machine locates the cutting tool against a fixtured workpiece and rotates the cutter at a suitable speed to power the metal removal operation(s). A typical toolholder has a generally round body with a tool holding end and a shank end. The shank end is sized and shaped to fit into a mating socket of the machine tool. Many toolholders have an annular collar or flange on their body, usually near the shank end, for a mechanized tool changer to grip and locate the toolholder as it moves it from storage to the machine tool spindle.

The CAT V-flange, steep taper (7/24) toolholder design is an example of a toolholder that is widely used. The shank of the CAT holder is tapered (like a truncated cone) in proportion to seven units of large diameter to 24 units of length. The holder comes in a wide range of sizes for different operations and machine spindle sizes, but the taper is closely formed to the 7/24 ratio. The flange on the CAT toolholder has a circumferential V-groove for more precise tool changer contact and gripping. This invention relates to a method to make a tapered shank tool holder like the CAT-V steep (7/24) taper design spindle-toolholder interface with higher damping characteristics to increase the dynamic bending stiffness for milling surfaces and boring holes in a single pass (operation).

A vibration dampening spacer made of flexible, deformable material (elastic material such as rubber, plastic, etc.) is located between the toolholder flange and the spindle face. The spacer is in the shape of a ring or donut to fit over the circumference of the toolholder. The spacer ring is compressed at the toolholder flange/spindle face interface by the clamping force of the spindle drawbar and creates a dampening effect, reducing cutting vibration, extending the cutting tool life and improving cutting regimes. It is found that the use of the spacer ring stabilizes a machining operation and increases spindle life. This spacer is adapted and selected for a machine tool spindle/toolholder combination to be able, for example, to mill selected faces in a die cast transmission case to a stringent flatness tolerance in a single milling pass. It provides consistent quality (with the proper finish and tolerance) and eliminates scrapped parts due to chatter marks.

Standard milling processes use multiple passes (rough and finish) to manufacture flat surfaces. In particular, a representative transmission case may have several surfaces with flatness requirements better than 0.05 mm (a narrow tolerance requirement for such large cross section surfaces). Rough operations generate large cutting forces resulting in micron scale motions between the female spindle taper and the male toolholder taper interface. This invention relates to conventional steep taper toolholder with a flexible (compressible material) spacer positioned at the interface. The flexible spacer is squeezed under the clamping force used to hold the toolholder in the spindle nose to optimize the stiffness and damping of the spindle-toolholder interface and reduce the micro motions of the toolholder especially at higher speeds.

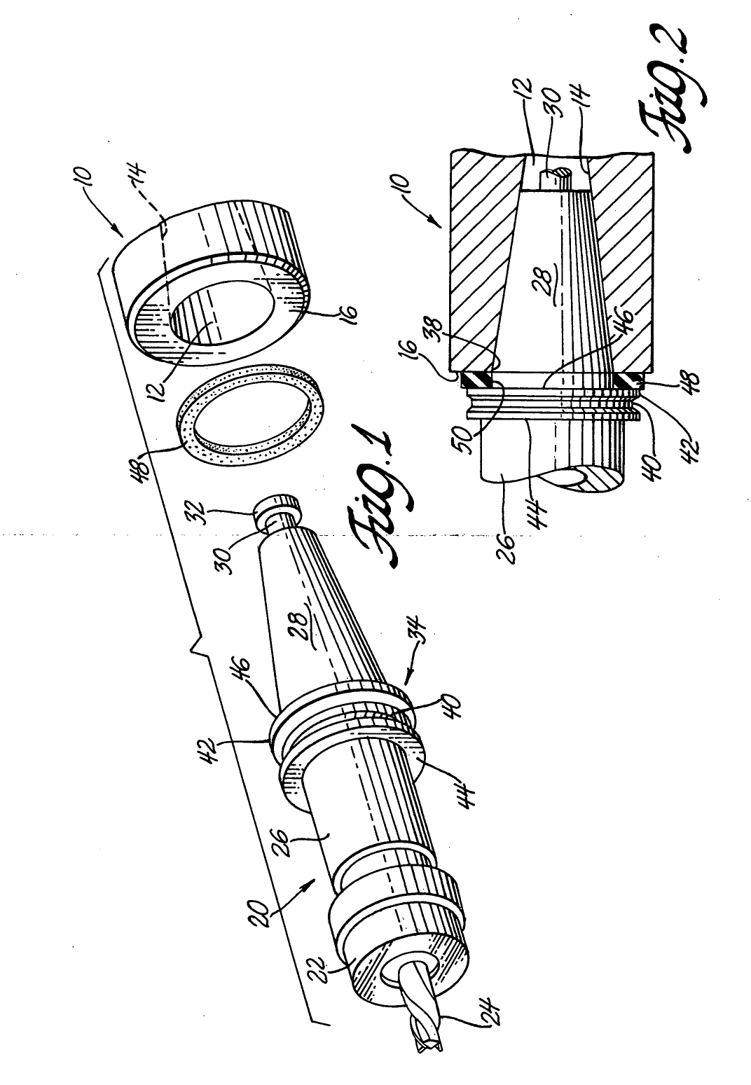

FIG. 1 illustrates an embodiment of the invention in an exploded oblique view. A fragmentary view of a CNC machine spindle is represented by spindle end 10. Spindle end 10 includes a tapered socket 12 with a machined conical surface 14. At the large diameter end of socket 12 is the face 16 of the spindle end 10. Included within the spindle is a pulling mechanism, a drawbar, not shown, for pulling the shank end of the toolholder into socket 12 into close engagement with conical surface 14.

Toolholder 20 is a round body for attaching a cutting tool to spindle end 10. Collet mechanism 22, or other suitable clamping mechanism, is attached to one end of the body 26 of toolholder 20 for holding fluted end mill tool 24. At the other end of body 26, toolholder 20 has a tapered shank 28 that is machined to closely fit against conical surface 14 of tapered socket 12. Fixed at the end of tapered shank 28 is a bolt 30 with bolt head 32 for grasping by a pulling mechanism, not shown, for securing and retaining shank 28 in socket 12.

Annular flange 34 is provided on circumferential surface of toolholder body 26 near the large diameter end 38 of tapered shank 28. Flange 34 has a radially extending V-groove 40 in its outer circumferential surface 42. Flange 34 and V-groove 40 are used by a tool exchanging mechanism, not shown, to automatically remove toolholder 20 and its cutting tool from a storage rack and place it with shank 28 in socket 12 of the machine tool. Flange 34 has radial faces 44 and 46. Flange radial face 44 faces toward collet mechanism end 22 of toolholder 20 and flange radial face 46 faces the shank 28. When toolholder 20 is fixed in spindle end 10 for a machining operation, radial face 46 is usually spaced a small distance, for example a millimeter or so, from spindle face 16.

In the practice of this invention, elastic spacer ring 48 is placed on and around the reduced diameter portion 50 of toolholder 20 adjacent the large diameter end 38 of shank 28 and against radial face 46 of flange 34. Elastic spacer ring has (1) an inside diameter to fit over the toolholder body portion 50 at the shank 28 end of the body, (2) an outside diameter as desired, but suitably compatible with the diameters of flange 34 and spindle face 16, and (3) a thickness for bridging the gap between flange face 46 and spindle face 16. When shank 28 of toolholder 20 is secured in spindle socket 12 spacer ring 48 is compressed between flange face 46 and spindle end face 16 as a vibration damper. This spatial relationship between the toolholder flange 34, spacer ring 48 and spindle face 16 is best seen in enlarged, partially cross-sectional view of FIG. 2.

As stated, in prior art toolholder-spindle connections there has been a small gap between radial face 46 of flange 34 and the face 16 of spindle end 10. In such a toolholder-spindle arrangement the only contact between the toolholder and the spindle is at the interface of the tapered shank and the tapered socket. The toolholder is made to fit into a separately made spindle and both mating parts have distinct manufacturing tolerances. In the machining of these mating toolholder shank and spindle socket surfaces, the allowable radial tolerance for the interface taper is split between the shank (toolholder taper) and the socket (machine spindle taper). Any error in the fit of the interface will result in increased loss of taper contact due to centrifugal force, runout at the tool tip, and out of tolerance parts. Runout error means that the center of the cutting tool rotation does not coincide with the center of spindle rotation. The part quality and cutting performance are affected significantly by the runout error. But the radial location accuracy for the toolholder shank and spindle socket is not adequate for precision applications since standard tolerances specify a minus deviation of the hole angle and a plus deviation of the toolholder angle, resulting in clearance between the back of the taper and the spindle hole. The major shortcoming of this interface is the radial clearance in the back of the taper. Such clearance reduces the stiffness of the toolholder/spindle assembly and increases runout, and potentially generates micro-motions, which cause fretting corrosion.

Special toolholders are available in which the toolchanger locating flange is located on surface 26 of toolholder 20 so that rigid face-to-face contact is obtained between flange face 46 and spindle face 16 when the toolholder shank is secured in ths spindle socket. This toolholder-spindle conection provides a dual contact between the toolholder and spindle, at the flange/spindle contacting faces and at the tapered interface between the shank and socket. Dual contact between the rigid and imperfectly fitting surfaces does reduce the toolholder micro-motions at low vibration frequencies. But machining difficulties remain. The shortcomings of the present toolholder/spindle connections are: (a) toolholder micro-motion at low and high frequencies with imperfect tapers, (b) machined surfaces are rough milled with poor flatness requiring a finish milling pass to improve the flatness, and (c) production time is long due to multiple passes.

This invention solves some of the shortcomings by using a donut spacer 48 at the toolholder-spindle interface (between the toolholder flange 34 and the spindle nose face 16 as illustrated in FIGS. 1 and 2). The spacer is made from suitable elastic material and is compressed somewhat between the toolholder flange and the spindle face by the preload of the clamping force. The clamping force is used to maintain the toolholder in the spindle pocket while the cutting tool, mounted at the front of the holder, is used to remove material from the workpiece. The spacer is squeezed behind the toolholder flange and the preload on the spacer is a function of the elastic module of the material. The spacer acts as damping enhancement, which reduces vibrations and/or dynamic loads in the toolholder-spindle interface system prone to dynamic effects. This reduces vibrations or dynamic loads. The spacer is made from flexible materials such as elastomers (rubbers), fiber-based materials (felt), plastics, and suitable composites. The selection of the flexible material is determined based on the clamping force of the toolholder, the cutting operation (milling, boring, etc.) and the cutting conditions. The characteristics of the toolholder-spindle interface are strongly affected by damping provided by the flexible spacer. The damping is affected by the preload and stiffness/compressibility of the flexible spacer.

### EXAMPLE

A CAT 40 toolholder with an end milling tool as depicted in FIG. 1 was subjected to dynamic tests and the frequency response function (FRF) of the toolholder-spindle system in the machine tool was measured. A CAT 40 toolholder is manufactured according to international specifications. In the example the 40 size tapered shank/spindle interface, the gage diameter of the spindle or toolholder taper (at the front or large end) is 44.450 mm and the taper length of the toolholder is 68.326 mm, the external diameter of the spindle is 88.90 mm, and the external diameter of the toolholder flange is 63.50 mm and the deviation accommodating clearance between the spindle face and the opposing end face of the toolholder flange is about 1 to 2 mm. For comparison purposes the standard tapered toolholder with and without the elastic damping spacer was tested. Elastic damping spacers used in tests described below were rings having an outside diameter of 62 mm, an inside diameter of 45 mm and a thickness of 3 mm.

Vibration Testing of the Toolholder-Spindle Interface.

Experimental study of structural vibration is widely used to understand and control the many vibration phenomena encountered in machining operations. Mathematical modal testing analysis is used for calculating the displacement-vibration frequency spectrum of machine tool structures. The dynamic test is conducted on a non-rotating toolholder-spindle setup and provides a response to measure and calculate the frequency response function (FRF) of the toolholder interface system.

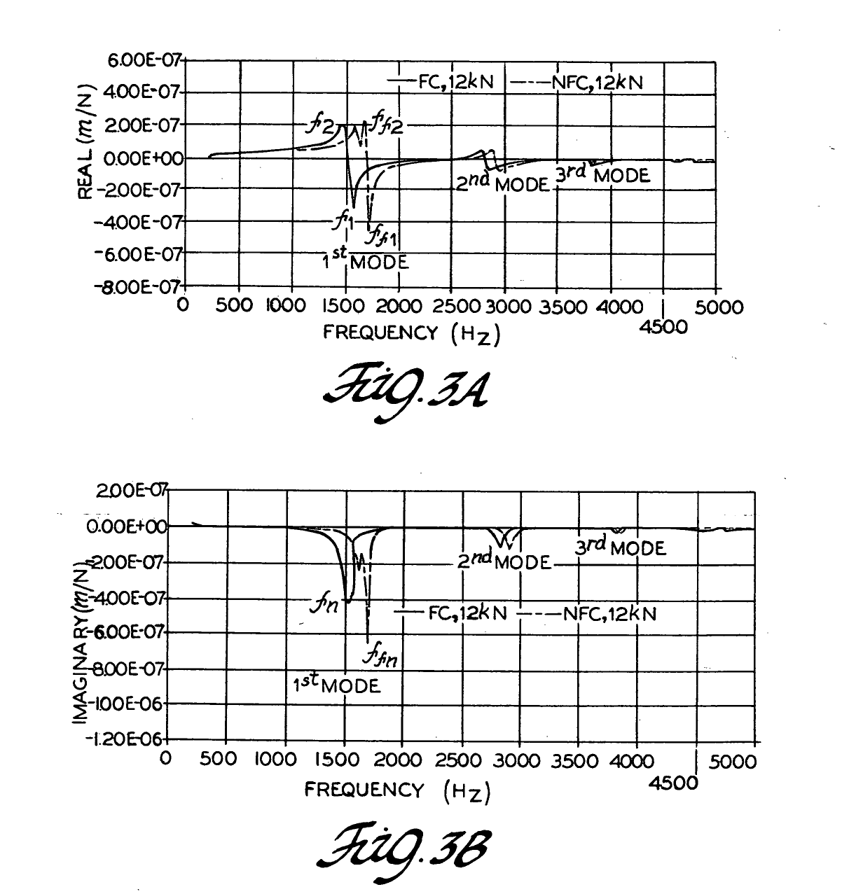

During dynamic testing, vibration of the toolholder is initiated with a known exciting force using an accelerometer instrumented, impulse force hammer and the resulting vibration response is measured using an accelerometer (piezoelectric transducer) attached with wax on the toolholder. Acceleration signals arising from the impact on the toolholder are conducted to a computer programmed with commercially available vibration analysis software. A displacement-frequency response function is obtained from the acceleration frequency response function through the analyzer. The frequency response function is obtained by taking fast Fourier transforms of the excitation force and the resulting displacement and dividing them by frequency. This frequency response function can be represented graphically using separate real and imaginary parts as shown in FIG. 3A and 3B.

Experimental Results and Analysis.

The comparative data graphs of FIGS. 3A and 3B were obtained by Fourier transform analysis of forced vibrations (exciting force of 12 kN) in the CAT 40 toolholder-spindle combination (1) with a poly (vinyl chloride) rubber spacer (curve FC in these figures) and (2) without any spacer between the toolholder flange and spindle face, curve NFC in FIGS. 3A and 3B.

Referring to FIG. 3A, there are two distinct peaks on the real part of the frequency response function for each mode of vibration. These peaks are located at f₂=1474.8 Hz and f₁=1574.7 Hz for the interface with the vinyl rubber spacer (FC) and f_{f2}=1676 Hz and f_{f1}=1718 Hz for the interface without a spacer (NFC). The location of these peaks give an indication of the amount of damping that is in the system. Damping reduces the frequency of the vibrations. For a system with little damping f₁ and f₂ are close together and for a system with a large amount of damping, these frequencies are farther apart. The shape of the real portion of the frequency response function also gives an indication of the how linear the system is. For a purely linear system, the heights of the real peaks will be equal in size but opposite in sign. As the system becomes nonlinear, the heights of the peaks will vary.

As seen in FIG. 3B, the imaginary part of the frequency response function has only one peak for each mode. This peak is located at fₙ=1523 Hz and at a height of −4.2612×10⁻⁷ m/N for the interface with the elastic spacer (FC) and f_{fn}=1703 Hz and at a height of −6.6192×10⁻⁷ m/N for the interface without the spacer (NFC). The frequency of this peak is representative of the natural frequency of the system while the height of the peak is related to the modal stiffness and damping ratio. From these frequencies and the height of the imaginary peak, the modal parameters for this mode of vibration can be determined. The damping ratio, [symbol] , can be approximated by substituting the frequencies f₁, f₂ and fₙ into equation 1

$$ζ = \frac{{f}_{1} - {f}_{2}}{2 \cdot {f}_{n}} \qquad ( 1 )$$

The height of the imaginary peak, h, is related to the modal stiffness, k, and the damping ratio according to equation 2, and allows for the calculation of the modal stiffness.

$$h = \frac{1}{2 \cdot k \cdot ζ} \qquad ( 2 )$$

The dynamic stiffness for the system is defined as the product of the modal stiffness k and the damping ratio [symbol] . Since the damping ratio and modal stiffness have the same effect on the dynamic stiffness of the system, the connection with the larger product of the damping ratio and modal stiffness will provide the highest dynamic stiffness. The stability of a mechanical system against chatter (vibration) is determined by the dynamic stiffness.

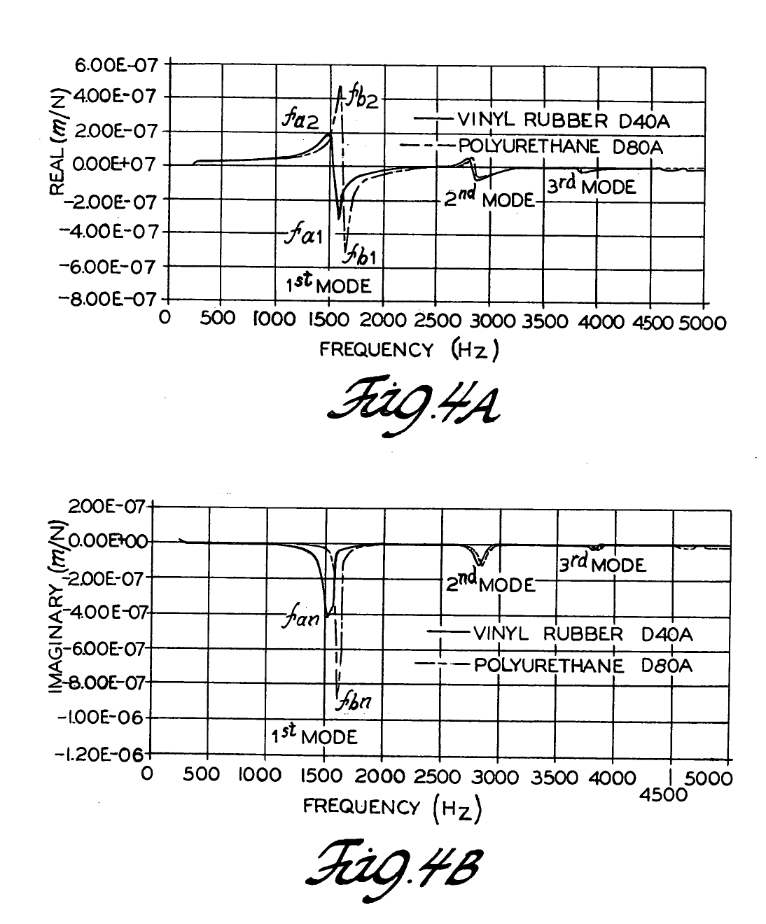

There are three modes of vibration as indicated in the FIGS. 3A, 3B, 4A and 4B, and the first mode is the most dominant vibrational mode. The experimental data from the FRF with respect to the natural frequency, modal stiffness, damping and dynamic stiffness for each of the three modes of vibration are given in Table 1 for the toolholder with and without the elastic damping spacer. The interface with the elastic damping spacer resulted in higher dynamic stiffness; the first mode provides 55 percent higher dynamic stiffness for the interface with the elastic spacer. The FRF can be adjusted by changing the thickness and compresibility (or durometer) of rubber.

The FRF is the ratio between the displacement of the system to an exciting force as a function of frequency. The frequency response can be represented using real and imaginary parts, which are used in machine tool dynamics to extract the modal parameters. Plots of the real and imaginary parts of the frequency response function for the toolholder-spindle interface with and without the flexible spacer were prepared and compared. The frequency of each peak in the imaginary part is representative of the natural frequencies of the system while the height of the peak is related to the modal stiffness and damping ration. The real part provides information about the damping of the system. The modal parameters for the toolholder-spindle interface are given in Table 1. The toolholder with an elastic rubber spacer at the back of its flange is identified as FC, while the toolholder with clearance at the flange is identified as NFC. The damping ratio and dynamic stiffness of the toolholder with the spacer “FC” is higher than that of the conventional holder “NFC” without a spacer.

TABLE 1
Bending FRF Measured for the CAT-40 Toolholder-Spindle
Interface With and Without Flexible Spacer at the Interface

| Holder | | | | ζ (Damping | Dynamic |
|---|---|---|---|---|---|
| Type | Mode | fₙ (Hz) | K (N/m) | Ratio) | Stiffness |
| FC | 1^{st} | 1523 | 3.58E+7 | .0328 | 11.74E+5 |
| | 2^{nd} | 2837 | 3.14E+8 | 0.0128 | 4.02E+5 |
| | 3^{rd} | 3827 | 3.01E+9 | 0.0062 | 1.87E+5 |
| NFC | 1^{st} | 1703 | 6.14E+7 | 0.0123 | 7.55E+5 |
| | 2^{nd} | 2916 | 3.64E+8 | 0.0109 | 3.97E+5 |
| | 3^{rd} | 3861 | 3.60E+9 | 0.0049 | 1.76E+5 |

FC: Toolholder with a Flexible Spacer at the interface
NFC: Conventional Toolholder (without a Spacer at the interface)

The toolholder with the vinyl rubber spacer between the flange face and the spindle face had a lower frequency in each vibration mode due to the desirable damping effect of the compressed spacer. Corresponding damping ratios and dynamic stiffness values were higher. The toolholder with vinyl rubber spacer was substitued for the toolholder without the spacer to mill a valve body face in a transmission case. The flatness of the valve body face was improved from a range of 0.03-0.06 mm deviations in height from surface profile flatness to a range of 0.02-0.045 mm deviations in height. This is a significant improvemt in milling performance because the desired flatness tolerance in this machining task was 0.05 mm as stated above in this specification.

Selection of Spacer Materials

The selection of a preferred spacer material for a spindle-toolholder interface depends on the intended use of the machine and the requirements of the different applications. In many cases, the aims are high metal removal rate (in milling, boring, etc.), or accurate surface location at higher spindle speeds. In both of these cases, the better selection criterion is dynamic stiffness (or chatter criterion k· [symbol] ) as seen at the tip of the tool. The selection of a spacer material can be made using vibration testing as described above. And an advantage of this invention is that a spacer of one material can be easily exchanged for another spacer material if the desired damping effect is not being obtained in a specific machining operation.

The elastic spacer material will affect the interface characteristics. The spacer material used in the test that produced the data in FIGS. 3A and 3B was vinyl rubber with a durometer value of 40A. Another test was performed using an elastic spacer made of polyurethane with durometer value of 80A. The results are shown in FIGS. 4A and 4B and in Table 2. The solid line data curves in FIGS. 4A and 4B are for the vinyl rubber with the 40A durometer value. This is the same FRF data as reported for the FC data in FIGS. 3A and 3B. The vinyl rubber peaks at fₐ₂, fₐ₁ and fₐₙ of FIGS. 4A and 4B correspond respectively to f₂, f₁ and fₙ in FIGS. 3A and 3B. The dashed line data in FIGS. 4A and 4B is the FRF data measured for the polyurethane spacer with peaks f_{b2} and f_{b1} measured on the real part of the function and f_{bn} measured on the imaginary pat of the function. The polyurethane material is less flexible or deformable than the rubber material and the resulting dynamic stiffness for the polyurethane was about 50 percent lower than that of the vinyl rubber material. Therefore, the stability improvement for the interface is affected by the selection of the elastic spacer material.

TABLE 2
Bending FRF Measured for the CAT-40 Toolholder-Spindle
Interface Using Two different Flexible Spacer Materials
at the Interface - Vinyl Rubber and Polyurethane

| Elastic | | | Modal | | |
|---|---|---|---|---|---|
| Spacer | | | Stiffness | ζ (Damping | Dynamic |
| Material | Mode | fₙ (Hz) | k (N/m) | Ratio) | Stiffness |
| Vinyl | 1^{st} | 1523 | 3.58E+7 | 0.0328 | 11.74E+5 |
| Rubber | 2^{nd} | 2837 | 3.14E+8 | 0.0128 | 4.02E+5 |
| | 3^{rd} | 3827 | 3.01E+9 | 0.0062 | 1.87E+5 |
| Polyurethane | 1^{st} | 1613 | 3.47E+7 | 0.0163 | 5.66E+5 |
| | 2^{nd} | 2858 | 3.04E+8 | 0.0118 | 3.59E+5 |
| | 3^{rd} | 3868 | 3.95E+9 | 0.0063 | 2.49E+5 |

Thus, the use of a suitable vibration dampening spacer ring between a toolholder flange face and the opposing face of a machine tool spindle can have a significant effect on the operation of a cutting tool. The dampening material is paired with the toolholder-spindle system to achieve its assigned task with less vibration and/or runout at the machining site and with improved machining dimensional accuracy and improved tool life and spindle life.

The invention has been described in terms of certain preferred embodiments. However, the scope of the invention is intended to be limited only by the following claims.

1. A toolholder for a machine tool having a shaft rotatable on a machining operation axis and having a conically tapered socket extending axially inwardly from an end face of said shaft, said toolholder comprising:
a round body for rotation on said machining axis, said body having a tool holding end, a tapered shank end for placement in said tapered socket of said shaft, and a radially extending flange adjacent said tapered shank, said flange having an annular surface facing said shank; and
a ring of elastic, vibration dampening material adapted to fit over said round toolholder body between said annular flange surface and said tapered shank, said ring having a thickness so that it is compressed between said flange surface and said end face of said shaft when said shank has been placed in said socket for a machining operation.

2. The toolholder as recited in claim 1 in which said ring comprises a vinyl rubber.

3. The toolholder as recited in claim 1 in which said ring comprises a polyurethane material.

4. The toolholder as recited in claim 1 in which said ring comprises a fibrous mat.

5. A method of reducing vibration during operational use of a cutting tool carried in a toolholder and powered through the interface of said toolholder with a machine tool spindle where said interface comprises a spindle with a tapered socket for said toolholder; and said toolholder comprises a tapered shank for insertion into said socket, and a flange face adjacent said shank and spaced from said spindle when said shank is inserted in said socket, said method comprising:
placing a vibration damping spacer of elastic material between said flange face and said spindle, said damping spacer being compressed between said toolholder flange and said spindle during operation of said cutting tool.

6. The method as recited in claim 5 in which said vibration damping spacer is a ring of elastic material.

7. The method as recited in claim 5 in which said elastic material comprises a vinyl rubber.

8. The method as recited in claim 5 in which said elastic material comprises a polyurethane material.

9. The method as recited in claim 5 in which said elastic material comprises a fibrous mat.

10. A method of reducing vibration during operational use of a cutting tool carried in a V-flange tapered toolholder and powered through the interface of said toolholder with a machine tool spindle where said interface comprises a spindle with a tapered socket for said toolholder; and said toolholder comprises a tapered shank for insertion into said socket, and a flange face adjacent said shank and spaced from said spindle when said shank is inserted in said socket, said method comprising:
placing a vibration damping spacer of elastic material between said flange face and said spindle, said damping spacer being compressed between said toolholder flange and said spindle during operation of said cutting tool.

11. The method as recited in claim 10 in which said vibration damping spacer is a ring of elastic material.

12. The method as recited in claim 10 in which said elastic material comprises a vinyl rubber.

13. The method as recited in claim 10 in which said elastic material comprises a polyurethane material.

14. The method as recited in claim 10 in which said elastic material comprises a fibrous mat.
